(19) United States
(12) Patent Application Publication
(10) Pub. No.: US 2023/0136858 A1
(43) Pub. Date: May 4, 2023

(54) HAND-SHAKING TYPE MILK FROTHING APPARATUS

(71) Applicant: Shenzhen Staresso Culture Co., Ltd., Shenzhen (CN)

(72) Inventor: Ke LI, Shenzhen (CN)

(21) Appl. No.: 17/691,473

(22) Filed: Mar. 10, 2022

(30) Foreign Application Priority Data
Nov. 2, 2021 (CN) 202122663557.1

(51) Int. Cl. A47J 43/27; A47J 43/12

(52) U.S. Cl. CPC A47J 43/27; A47J 43/121

(57) ABSTRACT

A hand-shaking type milk frothing apparatus is provided and includes: a cup body, a cup lid and a frothing device for frothing. The frothing device is disposed in the cup body, and a frothing space is reserved on both sides of the frothing device. The frothing device includes a magnetic connecting part for connecting to the cup lid and a frothing body connected to the magnetic connecting part. The cup lid is provided with a magnetic part corresponding to the magnetic connecting part, and a side wall of the frothing body is provided with a plurality of frothing holes. The hand-shaking type milk frothing apparatus has advantages of simple structure, easy to carry and clean, and can manually make milk foams anytime and anywhere.

### TECHNICAL FIELD

The disclosure relates to the technical field of household beverage processing tools, and more particularly to a hand-shaking type milk frothing apparatus.

### BACKGROUND

With improvement of living standards, people's demand for drinks is higher and higher. Taste of the drinks such as milk or coffee after stirring and frothing is much better than original products without the frothing. Especially for the coffee and other drinks, for taste needs of the general public, they often match sugar bags or milk foams (also referred to as milk froths) to reconcile the bitterness of the coffee.

However, the production of existing milk foams is often stirred by rotating agitators. When a linear agitator is immersed on the liquid surface for frothing, a contact area between the liquid and the air is less, the efficiency of the frothing is low, the milk foams formed are big and easy to burst, and the maintenance time of the milk foams is short. When the linear agitator is immersed in the liquid, the resistance of the stirring is increased, the stirring speed is decreased greatly, and it is difficult to make the milk foams compact. In particular, for viscous dairy products, nonprofessional milk frothing apparatus, such as the conventional portable hand-held milk frothing rod, it has low stirring force and is not easy to form the milk foams.

### SUMMARY

A technical problem to be solved by the disclosure is to provide a hand-shaking type milk frothing apparatus, which has a simple structure, is easy to carry and clean, and can manually make milk foams anytime and anywhere.

In order to solve the above technical problem, the disclosure provides the hand-shaking type milk frothing apparatus, including: a cup body, a cup lid, and a frothing device for frothing; the frothing device is disposed in the cup body, and a frothing space is reserved on both sides of the frothing device; and the frothing device includes a magnetic connecting part (also referred to as magnetic connector) for connecting to the cup lid and a frothing body connected to the magnetic connecting part, the cup lid is provided with a magnetic part corresponding to the magnetic connecting part, and a side wall of the frothing body is provided with a plurality of frothing holes.

In an embodiment, the magnetic connecting part includes a connecting part and a first magnetic block magnetically attractable to the magnetic part, the first magnetic block is disposed on a bottom surface of the connecting part, and the frothing body is connected to the connecting part.

In an embodiment, the magnetic connecting part further includes a protective cover, the protective cover is connected to the connecting part to form a protective cavity, and the first magnetic block is disposed in the protective cavity.

In an embodiment, the frothing body is provided with an inner frothing space therein, a bottom of the inner frothing space is connected to the frothing space, and two sides of each of the plurality of frothing holes are respectively connected to the inner frothing space and the frothing space.

In an embodiment, the frothing body includes a frothing net and an inner support, the frothing net is disposed on two sides of the connecting part, a top of the frothing net is connected to the connecting part, a bottom of the frothing net is connected to the inner support, the frothing net defines the inner frothing space therein, and the inner support is disposed in the inner frothing space.

In an embodiment, the frothing net is tubular, the inner support is annular, and the connecting part and the inner support are respectively connected to upper and lower ends of the frothing net.

In an embodiment, the side wall of the frothing body is further provided with flow-through holes for improving fluidity, and a cross-sectional area of each of the flow-through holes is larger than that of each of the plurality of frothing holes.

In an embodiment, each of the flow-through holes is a strip-shaped hole, and a minimum width of each of the flow-through holes is greater than a diameter of each of the plurality of frothing holes.

In an embodiment, the cup lip is provided with a groove matching with the connecting part, and the magnetic part is arranged corresponding to the groove.

In an embodiment, the frothing device includes a tubular frame and at least one mesh sheet; a side wall of the tubular frame is provided with at least one mesh sheet receiving opening, and each of the at least one mesh sheet receiving opening is provided with one of the at least one mesh sheet therein.

The beneficial effects of the disclosure are as follows:

in the disclosure, the hand-shaking type milk frothing apparatus includes the cup body, the cup slip, the frothing device for the frothing and other parts, without additional stirring rods and power components, has simple structure, small weight and is easy to carry.

Moreover, the frothing device includes the magnetic connecting part for connecting with the cup slip and the frothing body connected with the magnetic connecting part, the cup slip is provided with the magnetic part corresponding to the magnetic connecting part, so the frothing device can be directly connected to the cup lip by the magnetic suction. When the hand-shaking type milk frothing apparatus is cleaned, the frothing device can be directly pulled out by hand for separate cleaning.

In addition, the frothing device is disposed in the cup body, the side wall of the frothing device is provided with the plurality of frothing holes, and the two sides of the frothing device is reserved with the frothing space. Therefore, after pouring an appropriate amount of milk into the cup body and shaking the hand-shaking type milk frothing apparatus, the milk inside will collide back and forth in the cup body, and have a great contact area and contact time with the air in the cup body, through the frothing holes, it is easy to form the milk foams and the milk foams are fluffy.

### BRIEF DESCRIPTION OF DRAWINGS

FIG. 1 is a schematic exploded view of a hand-shaking type milk frothing apparatus according to a first embodiment of the disclosure.

FIG. 2 is a schematic cross-sectional view of partial structures of the hand-shaking type milk frothing apparatus according to the first embodiment of the disclosure;

FIG. 3 is a schematic exploded view of the frothing device according to the first embodiment of the disclosure;

FIG. 4 is a schematic exploded view of a hand-shaking type milk frothing apparatus according to a second embodiment of the disclosure.

### DETAILED DESCRIPTION OF EMBODIMENTS

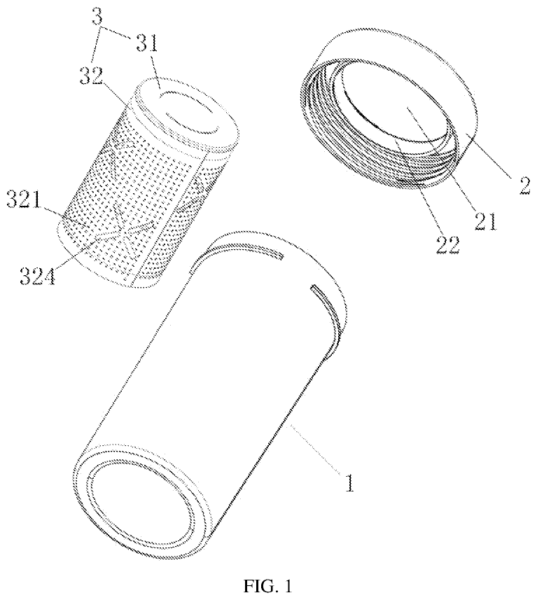

In order to make the purpose, technical scheme and advantages of the disclosure clearer, the disclosure is further described in detail below in combination with the attached drawings and embodiments. Only for this statement, the words in the upper, lower, left, right, front, rear, inner and outer directions of the disclosure that appear or will appear in the description are only based on the attached drawings of the disclosure, which is not a specific limitation of the disclosure. Only a part of a structure of a magnetic connecting part 31 is shown in FIG. 1, and the specific structure is based on the description.

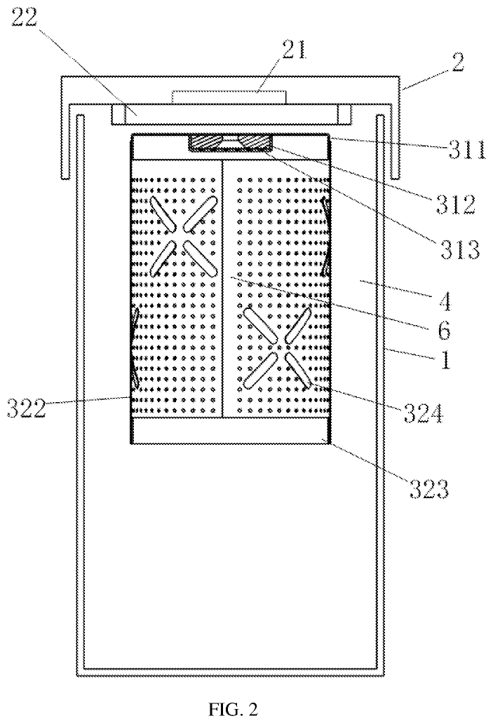

As shown in FIG. 1 and FIG. 2, a first embodiment of the disclosure provides a hand-shaking type milk frothing apparatus, including: a cup body 1, a cup lid 2 and a frothing device 3 for frothing. The frothing device 3 is disposed in the cup body 1, and a frothing space 4 is reserved on both sides of the frothing device 3.

In an exemplary embodiment, the frothing device 3 includes a magnetic connecting part 31 for connecting to the cup lid 2 and a frothing body 32 connected to the magnetic connecting part 31. The cup lid 2 is provided with a magnetic part 21 corresponding to the magnetic connecting part 31. A side wall of the frothing body 32 is provided with a plurality of frothing holes 321.

Specifically, the magnetic connecting part 31 includes a connecting part 311 and a first magnetic block 312 magnetically attractable to the magnetic part 21. The first magnetic block 312 is disposed on a bottom surface of the connecting part 311. The frothing body 32 is connected to the connecting part 311. The connecting part 311 is clamped between the first magnetic block 312 and the magnetic part 21 to restrict the separation between the connecting part 311 and the cup lip 2 when the first magnetic block 312 and the magnetic part 21 attract each other.

Moreover, in order to limit the shaking of the frothing device 3 relative to the cup lip 2 during the shaking and frothing operation, the cup lip 2 is provided with a groove 22 matching with the connecting part 311, and the connecting part 311 is embedded in the groove 22. Accordingly, the magnetic part 21 is arranged corresponding to the groove 22, so that after the connecting part 311 is placed in the groove 22, the magnetic part 21 and the first magnetic block 312 can be arranged corresponding to each other. The magnetic part 21 can be an iron block or a magnet, and the first magnetic block 312 can be a magnet. When the magnetic part 21 is the magnet, the first magnetic block 312 can be the iron block attracted to the magnet.

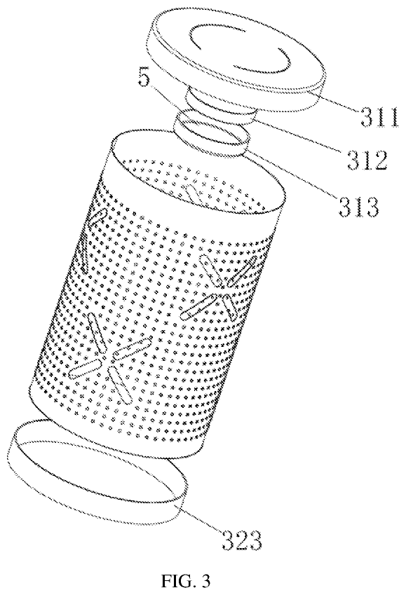

As shown in FIG. 3, in order to avoid corrosion and oxidation of the first magnetic block 312, the magnetic connecting part 31 further includes a protective cover 313, the protective cover 313 is connected to the connecting part 311 to form a protective cavity 5, and the first magnetic block 312 is disposed in the protective cavity 5.

In an exemplary embodiment, the frothing body 3 is provided with an inner frothing space 6 therein, a bottom of the inner frothing space 6 is connected to the frothing space 4, and two sides of each of the plurality of frothing holes 321 are respectively connected to the inner frothing space 6 and the frothing space 4. Therefore, during manual frothing, the shaking of hands will make the milk flow into the inner frothing space 6 and the frothing space 4, and make the milk pass through the frothing holes 321 to obtain the frothing effect, so as to improve the efficiency of the frothing.

In an exemplary embodiment, in order to ensure the portability of the hand-shaking type milk frothing apparatus of disclosure, the frothing body 32 is generally light and thin, so as to reduce the self-weight and the use cost of materials. Therefore, the frothing body 32 is generally made of a thinner plate. Moreover, in order to ensure that the frothing body 32 can withstand impact without deformation during the frothing, the frothing body 32 includes a frothing net 322 and an inner support 323. The frothing net 322 is disposed on two sides of the connecting part 311. A top of the frothing net 322 is connected to the connecting part 311. A bottom of the frothing net 322 is connected to the inner support 323. The frothing net 322 defines the inner frothing space 6 therein. The inner support 323 is disposed in the inner frothing space 6. The frothing net 322 can be a sheet-shaped structure, and the overall stiffness of the frothing body 32 can be improved by adding a number of the frothing net 322. The frothing net 322 is provided with a plurality of frothing holes 321. In order to better improve the overall rigidity of the frothing body 32, the frothing net 322 is tubular, the inner support 323 is annular, and the connecting part 311 and the inner support 323 are respectively connected to the upper and lower ends of the frothing net 322.

In an exemplary embodiment, in order to make users have better hand feel and obtain better frothing effect, the side wall of the frothing body 32 is further provided with flow-through holes 324 for improving fluidity, and a cross-sectional area of each of the flow-through holes 324 is larger than that of each of the plurality of frothing holes 321. The setting of the flow-through holes 324 can ensure a certain high fluidity between the inner frothing space 6 and the frothing space 4, so that the user can always feel a stream of milk shuttling back and forth between the inner frothing space 6 and the frothing space 4 in the process of manual shaking, so as to optimize the experience of manual frothing and master the rhythm of frothing.

In an exemplary embodiment, each of the flow-through holes 324 is a strip-shaped hole, and a minimum width of each of the flow-through holes 324 is greater than a diameter of each of the plurality of frothing holes 321. For example, the diameter of the frothing hole 321 is less than 1 millimeter (mm), so that the milk foams formed by hand frothing are smaller and more compact, and the milk foams are maintained for a longer time.

In an exemplary embodiment, an inner bottom surface of the cup lip 2 is provided with a sealing groove for placing a gasket, so as to seal a cup mouth after the cup body is closed with the cup lip to avoid liquid leakage.

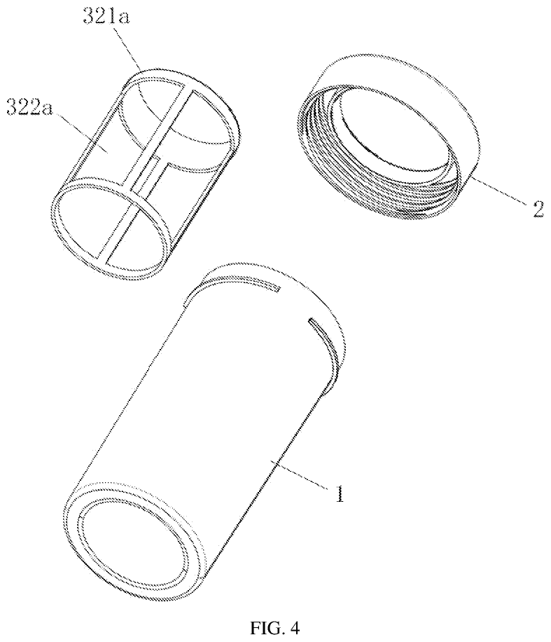

As shown in FIG. 4, a second embodiment of the disclosure provides a hand-shaking type milk frothing apparatus, compared with the hand-shaking type milk frothing apparatus of the first embodiment, the difference is, the frothing device 3 includes a tubular frame 321a and at least one mesh sheet (not shown in figures). A side wall of the tubular frame 321a is provided with at least one mesh sheet receiving opening 322a. Each of the at least one mesh sheet receiving opening 322a is provided with one of the at least one mesh sheet.

In an exemplary embodiment, the specific number of the mesh sheet receiving opening 322a and the specific number and layers of the mesh sheet can be set according to the capacity of the cup body and the viscosity of common dairy products. For example, the number of the mesh sheet receiving opening 322a is four. The mesh sheet receiving openings 322a are circumferentially distributed on the side wall of the tubular frame 321a, and a plurality of the mesh sheets are correspondingly arranged on the mesh sheet receiving openings 322a one by one to improve the frothing speed.

In an exemplary embodiment, the tubular frame 321a is horn-shaped. It should be noted that since the mesh sheet receiving opening 322a is arranged on the side wall of the horn-shaped tubular frame, a certain angle is formed between the mesh sheet and the bottom surface of the cup body 1, so that the user can make the milk foams when shaking up and down, so as to adapt to the shaking habit of the user.

The above description is only exemplary embodiments of the disclosure. It should be pointed out that for the person skilled in the related art, any improvements and refinements can be made without departing from the principles of the disclosure, which are also regarded as the protection scope of the disclosure.

What is claimed is:

1. A hand-shaking type milk frothing apparatus, comprising: a cup body, a cup lid, and a frothing device for frothing;
wherein the frothing device is disposed in the cup body, and a frothing space is reserved on both sides of the frothing device; and
wherein the frothing device comprises a magnetic connecting part for connecting to the cup lid and a frothing body connected to the magnetic connecting part, the cup lid is provided with a magnetic part corresponding to the magnetic connecting part, and a side wall of the frothing body is provided with a plurality of frothing holes.

2. The hand-shaking type milk frothing apparatus according to claim 1, wherein the magnetic connecting part comprises a connecting part and a first magnetic block magnetically attractable to the magnetic part, the first magnetic block is disposed on a bottom surface of the connecting part, and the frothing body is connected to the connecting part.

3. The hand-shaking type milk frothing apparatus according to claim 2, wherein the magnetic connecting part further comprises a protective cover, the protective cover is connected to the connecting part to form a protective cavity, and the first magnetic block is disposed in the protective cavity.

4. The hand-shaking type milk frothing apparatus according to claim 1, wherein the frothing body is provided with an inner frothing space therein, a bottom of the inner frothing space is connected to the frothing space, and two sides of each of the plurality of frothing holes are respectively connected to the inner frothing space and the frothing space.

5. The hand-shaking type milk frothing apparatus according to claim 4, wherein the frothing body comprises a frothing net and an inner support, the frothing net is disposed on both sides of the connecting part, a top of the frothing net is connected to the connecting part, a bottom of the frothing net is connected to the inner support, the frothing net defines the inner frothing space therein, and the inner support is disposed in the inner frothing space.

6. The hand-shaking type milk frothing apparatus according to claim 5, wherein the frothing net is tubular, the inner support is annular, and the connecting part and the inner support are respectively connected to upper and lower ends of the frothing net.

7. The hand-shaking type milk frothing apparatus according to claim 1, wherein the side wall of the frothing body is further provided with flow-through holes for improving fluidity, and a cross-sectional area of each of the flow-through holes is larger than that of each of the plurality of frothing holes.

8. The hand-shaking type milk frothing apparatus according to claim 7, wherein each of the flow-through holes is a strip-shaped hole, and a minimum width of each of the flow-through holes is greater than a diameter of each of the plurality of frothing holes.

9. The hand-shaking type milk frothing apparatus according to claim 2, wherein the cup lip is provided with a groove matching with the connecting part, and the magnetic part is arranged corresponding to the groove.

10. The hand-shaking type milk frothing apparatus according to claim 1, wherein the frothing device comprises a tubular frame and at least one mesh sheet, a side wall of the tubular frame is provided with at least one mesh sheet receiving opening, and each of the at least one mesh sheet receiving opening is provided with one of the at least one mesh sheet therein.
